(19) United States
(12) Patent Application Publication
(10) Pub. No.: US 2009/0211415 A1
(43) Pub. Date: Aug. 27, 2009

(54) Onion chopping devices and methods of use thereof

(76) Inventor: Syed Rizvi, Hemet, CA (US)

Correspondence Address: Syed Rizvi, 200 North Yale Street #112, Hemet, CA, 92544, US

(21) Appl. No.: 12/072,056

(22) Filed: Feb. 22, 2008

(51) Int. Cl. B26D 3/00

(52) U.S. Cl. 83/15

(57) ABSTRACT

The present invention generally relates to certain novel methods of chopping onions, while avoiding (or reducing) exposure to syn-propanethial-S-oxide gas emitted from such onions. In certain embodiments, the methods generally comprise placing an onion on a cutting platform, applying heat to the cutting platform or the air surrounding the cutting platform, and applying a vacuum pressure to the air surrounding the cutting platform. In certain specific embodiments, the methods generally comprise (a) placing a cutting platform sufficiently near a heat source and ventilation hood such that air directly above the cutting platform increases in temperature and exhibits a vacuum force towards the ventilation hood when the heat source and ventilation hood are activated, (b) activating the heat source and ventilation hood, and (c) cutting the onion on the cutting platform.

### FIELD OF THE INVENTION

The field of the present invention relates to methods and devices for cutting produce. More particularly, the present invention relates to methods and devices for minimizing exposure to noxious and irritating gasses that are emitted from certain freshly cut produce, such as the syn-propanethial-S-oxide gas emitted from freshly cut onions.

### BACKGROUND OF THE INVENTION

It is well-known that various types of freshly cut produce emit noxious gasses that, for example, irritate eyes and cause unwanted tear production. Such gasses have also been implicated in abnormal vision, anxiety, fatigue, lack of concentration, mood disorders, decreased productivity, potential cardiovascular problems, and central nervous system abnormalities. Of course, these symptoms may affect the social, personal, and professional lives of individuals, particularly culinary professionals (and others working in the food industry).

Among the most well-known gasses is syn-propanethial-S-oxide, which is emitted from freshly cut onions. Indeed, most are familiar with the irritating and tear-causing that results from cutting and chopping onions in open air. Syn-propanethial-S-sensation oxide is gaseous at room temperature. The formation of syn-propanethial-S-oxide peaks at about 30 seconds after mechanical damage to an onion and completes its cycle of chemical evolution over the course of about five minutes. As the gas leaves the onion and begins to mix with the air, it may quickly contact and dissolve in the watery film that covers a person's eyes. This combination produces sulfuric acid, which irritates the nerve-endings found in the cornea, resulting in elevated tear production until such acid is sufficiently diluted and/or removed.

A number of devices have been developed in attempt to minimize the extent to which such gasses contact a person's eyes during onion cutting procedures. Many of these devices, however, suffer from one or more drawbacks. For example, many of these devices (i) are not able to prevent a substantial portion of the undesirable noxious gas from contacting a person's eyes, (ii) leave the gas trapped in a chamber which must later be cleaned (thereby potentially exposing the user to such gas during the cleaning process), (iii) are not adapted for household or individual use, and/or (iv) require the use and purchase of elaborate and expensive machinery. In light of the foregoing, a continuing need exists for improved devices and methods that may be used to cut produce, while minimizing exposure to certain noxious gasses that are emitted by such freshly cut produce, e.g., minimizing exposure to the syn-propanethial-S-oxide gas that is emitted by freshly cut onions.

As the following will demonstrate, many of the foregoing needs are provided by the present invention.

### SUMMARY OF THE INVENTION

According to a first aspect of the present invention, methods of chopping onions are provided, which enables a person to avoid (or reduce) exposure to syn-propanethial-S-oxide gas emitted from such onions. In certain embodiments, the methods generally comprise placing an onion on a cutting platform, applying heat to the cutting platform or the air surrounding the platform, and applying a vacuum to the air surrounding the cutting platform. The invention provides that the addition of heat to the cutting environment serves to neutralize the syn-propanethial-S-oxide gas, while the vacuum is effective to remove the syn-propanethial-S-oxide gas from the environment and eliminate (or reduce) the amount of such gas to which a person is exposed.

According to additional aspects of the present invention, methods of chopping onions are provided, which generally comprise placing a cutting platform near a heat source and ventilation hood, such as the burners and ventilation hood of a conventional stove. The cutting platform should be positioned sufficiently close to the stove burners and ventilation hood such that air directly above the cutting platform increases in temperature and exhibits a vacuum force towards the ventilation hood (when the heat source and ventilation hood are activated). According to such embodiments, the methods further comprise activating the heat source and ventilation hood, and cutting the onion on the cutting platform.

According to further aspects of the present invention, methods of chopping onions are provided, which generally comprise (a) placing the onion on a portable cutting platform, (b) activating a heat source that is located next to, below, or is integrally formed with the portable cutting platform, (c) activating a ventilation fan located next to or above the cutting platform, and (d) cutting the onion.

According to yet further aspects of the present invention, portable devices for chopping onions are provided. Such devices generally comprise a cutting platform that is located directly above, adjacent to, and/or is integrally formed with a heat source. In such embodiments, the heat source will be capable of, directly or indirectly, heating the air directly above the cutting platform. The portable devices of the present invention further comprise a ventilation fan that is capable of removing and/or trapping syn-propanethial-S-oxide propanethial-S-oxide gas that is emitted from a freshly cut onion.

The above-mentioned and additional features of the present invention are further illustrated in the Detailed Description contained herein.

### BRIEF DESCRIPTION OF THE FIGURES

FIG. 1: A drawing of a non-limiting example of a cutting platform and platform base that may be used in the methods described herein.

FIG. 2: A drawing of the cutting platform and platform base of FIG. 1, with the cutting platform having three legs instead of four.

FIG. 3: A drawing of a non-limiting example of a cutting platform that is integrally formed with a platform base, which may be used in the methods described herein.

FIG. 4: A topside view of a conventional stove range that comprises four separate burners, which may be used in the methods described herein.

FIG. 5: A drawing illustrating a non-limiting example of a device of the present invention, which includes a portable cutting platform, a heat source (or heated base), and a ventilation fan.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

According to certain preferred embodiments of the present invention, methods of chopping onions are provided, while avoiding (or reducing) exposure to syn-propanethial-S-oxide gas emitted from such onions. In certain preferred embodiments, the methods generally comprise placing an onion on a cutting platform, applying heat to the cutting platform or the air surrounding the platform, and applying a vacuum to the air surrounding the cutting platform. The invention provides that by applying heat and vacuum pressure to the cutting environment, the syn-propanethial-S-oxide gas emitted from freshly cut onions is neutralized (by the heat) and carried away (by the vacuum pressure created by, for example, a ventilation hood). The combination of heat and vacuum pressure applied to the cutting environment is effective to eliminate (or reduce) the amount of such gas to which a person would otherwise be exposed while cutting onions.

In certain preferred embodiments of the invention, the methods of chopping onions utilize a heat source and/or ventilation hood that is a part of an ordinary kitchen. For example, in certain embodiments, the heat source may be one or more burners of a conventional stove, including gas or electric burners. In addition, for example, the ventilation hood used in the methods described herein may be the ventilation hood that is installed above, next to, or is integrally formed with a conventional stove (e.g., certain ventilation means may be located between (or next to) the burners on the stove surface). Thus, according to certain embodiments, the invention enables the methods described herein to be performed without having to purchase an expensive heat source and/or ventilation hood; rather, such components may be used as found in a typical kitchen.

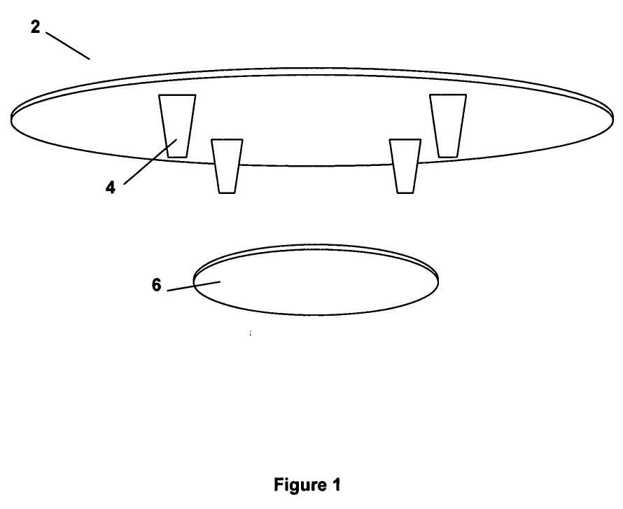

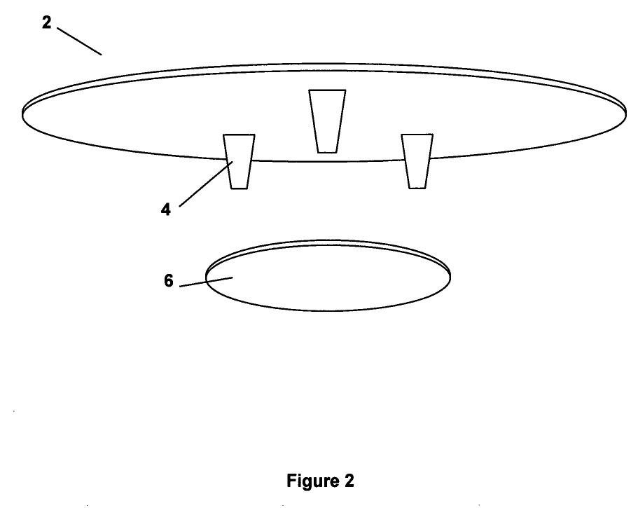

According to certain preferred embodiments of the present invention, methods of chopping onions are provided, which generally comprise placing a cutting platform near a heat source and ventilation hood, such as the burners and ventilation hood of a conventional stove. Referring to FIG. 1, the cutting platform may be configured as a circular (or other appropriately-shaped) tray 2, which may optionally include a series of legs 4 attached to the bottom side thereof. The cutting platform may optionally be provided with two, three, four, or any number of legs 4, which allow the cutting platform to be placed on a surface, such as above a stove burner or on a stove surface between burners, in a stable manner. For example, the cutting platform of FIG. 1 includes a series of four legs 4, whereas the cutting platform of FIG. 2 includes a series of three legs 4. According to these embodiments, the ventilation hood is positioned above, next to, or is integrated within the stove.

The cutting platform should be positioned sufficiently close to the burners and ventilation hood such that air directly above the cutting platform increases in temperature and exhibits a vacuum force towards the ventilation hood (when the burners and ventilation hood are activated). According to such embodiments, the methods further comprise activating the burners and ventilation hood, and cutting the onion on the cutting platform.

The invention provides that the cutting platform may be positioned a predefined distance above a burner on the stove. For example, referring to FIG. 1, the legs 4 may elevate the platform a predefined distance above a burner on the stove. The predefined distance may range between 0.5 to 6 inches, preferably between 1 and 3 inches, and most preferably about 2 inches. In certain embodiments, a platform base 6 may be placed on the burner. The legs 4 of the cutting platform 2 may then be placed on top of the platform base 6. Alternatively, the legs 4 of the cutting platform 2 may straddle the entire burner and platform base 6 (as the platform base 6 sits on the burner), provided that the legs 4 are spread far enough apart. In view of the foregoing, the platform base 6 may be used to serve as a flat foundation on which the cutting platform 2 may be placed, provided that the legs 4 thereof are positioned in sufficient proximity to each other to be capable of sitting on the platform base 6. In addition, the platform base 6 may serve to prevent flames of a gas burner from coming into contact with (or coming into close proximity to) a person's hands while cutting an onion on the cutting platform 2. The cutting platform 2 and platform base 6 may be configured in any shape, such as the circular shape shown in FIGS. 1 and 2. In addition, the cutting platform 2 and platform base 6 may be of any suitable size, such as 12 inches and 6 inches in diameter, respectively.

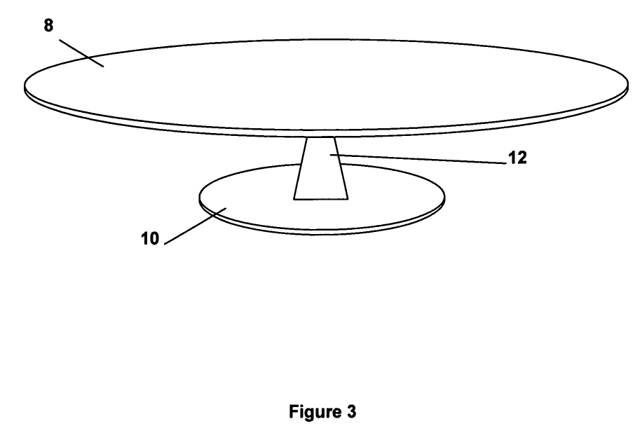

According to additional embodiments, referring to FIG. 3, a cutting platform 8 and platform base 10 may be integrally formed and/or connected to each other. In the example shown in FIG. 3, the cutting platform 8 is attached to the platform base 10 by a single support component 12. In the embodiments shown in FIGS. 1-3, the legs 4 or support component 12 cause the cutting platform 2,8 to be located a certain predefined distance, such as 2 inches, above the plane of a heat source (e.g., the top surface of a stove burner) or the plane of a stove surface (e.g., in the case where the cutting platform 2,8 is placed adjacent or next to an activated burner instead of over the burner).

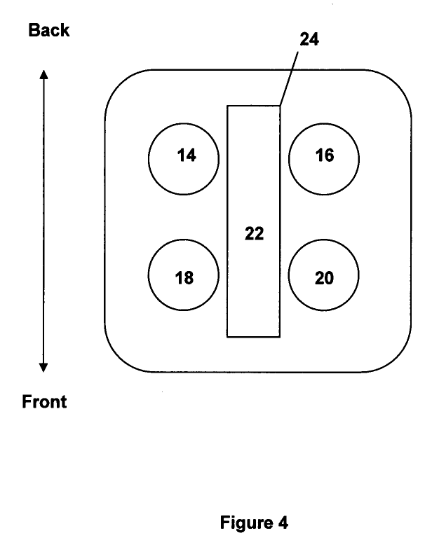

Referring to FIG. 4, the cutting platform 2,8 may be positioned on top of an activated burner of a stove or adjacent to an activated burner. As described above, when the cutting platform 2,8 is placed on top of an activated burner, the platform base 6,10 and legs 4 or support component 12 will elevate the cutting surface of the cutting platform 2,8 such that the air around it will be sufficiently warmed by the burner, while still being positioned a safe distance from the burner such that an onion may be safely and comfortably chopped thereon.

As used herein, the phrase “the cutting platform is positioned adjacent to at least one stove burner,” and similar phrases, means that the cutting platform is located anywhere on a stove surface that is sufficiently close to the activated burner such that the temperature of the air above the cutting platform will be increased (relative to the ambient room temperature). Preferably, the temperature of the air above the cutting platform will be increased by 2, 4, 6, 8, 10, 20, 30, 40, or more degrees Fahrenheit above ambient room temperature. For example, referring to FIG. 4, if burner 14 is activated, a cutting platform would be considered positioned adjacent to at least one burner if it were placed on top of burners 16 or 18 (or burner 20, provided that burner 14 emits sufficient heat and/or burner 20 is sufficiently close to burner 14 such that the air temperature above burner 20 is increased). Still further, for example, if burner 14 is activated, a cutting platform would be considered positioned adjacent to at least one burner if it were placed between burners 18 and 20, such as in position 22.

Still referring to FIG. 4, according to certain preferred embodiments, the cutting platform may be placed on a non-activated first burner that is closest to a user, such as burner 18 or 20, which is adjacent to an activated second burner that is located a greater distance from the user than the first burner, such as burner 14 or 16, respectively. In other words, the invention provides that it may be preferred to position the cutting platform on a non-activated first burner 18, and activate burner 14 (and, optionally, burner 16 as well) as the heat source. Alternatively, it may be preferred to position the cutting platform on a non-activated first burner 20, and activate burner 16 (and, optionally, burner 14 as well) as the heat source. According to these embodiments, it can be said that the cutting platform is placed on any of the front burners (burners 18 or 20), and the back burners (burners 14 or 16) are activated and used as the heat source. This way, a user's hands and arms are not reaching over a stove burner, thereby increasing the safety of the methods described herein. In other words, the activated burners are located a greater distance from the user, compared to the burners on which the cutting platform is positioned. Alternatively, the cutting platform may be positioned on the stove surface between the front burners 22, while still using the back burners (burners 14 and/or 16) as the heat source.

In certain alternative embodiments, a cutting platform 2 may not be provided with any legs 4, nor employ the use of a platform base 6. According to these embodiments, the cutting platform 2 alone may be positioned on top of (or adjacent to) an activated burner of a stove and, in such case, the cutting platform 2 would not be elevated above the plane of a burner or stove surface.

As described above, the ventilation hood may comprise a conventional ventilation hood located above the stove range, which is capable of sucking air above a burner into the hood, thereby creating a vacuum pressure directly above the burners. Alternatively, in certain stove ranges, the ventilation hood may be located on the surface of the stove, such as in the middle of the burners 24, such that air is drawn from just above the burners and into the ventilation hood (i.e., ventilation sink) located between the burners 24.

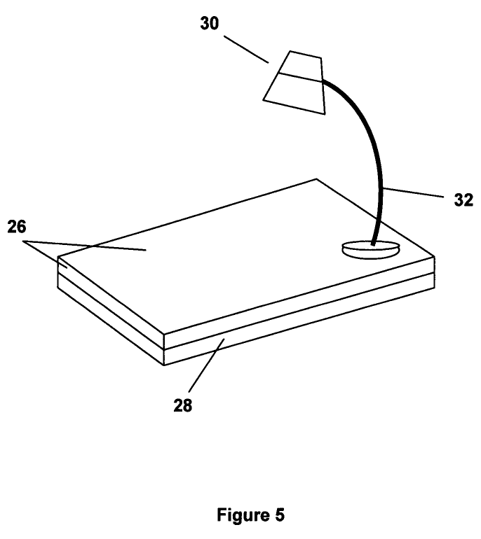

According to further embodiments of the present invention, methods of chopping onions are provided which generally comprise (a) placing the onion on a portable cutting platform, (b) activating a heat source that is located next to, below, or is integrally formed with the cutting platform, (c) activating a ventilation fan located next to or above the cutting platform, and (d) cutting the onion. The portable cutting platforms and devices that may be used in such methods, which are also encompassed by the present invention, generally comprise a cutting platform that is located directly above, adjacent to, and/or is integrally formed with a heat source. For example, referring to FIG. 5, the cutting platform 26 may rest directly on top of a heat source (or heated base) 28. Although the portable device shown in FIG. 5 is configured as a rectangular object, it will be appreciated that it may take on any shape and form. In addition, instead of having the cutting platform 26 rest directly on top of a flat heated base 28, the heat source may be a heated coil or other apparatus that is located along the perimeter (or resides within the interior portion) of the cutting platform 26. In such embodiments, the heat source will be capable of, directly or indirectly, heating the air above the cutting platform 26.

The portable devices of the present invention further comprise a ventilation fan 30 that is capable of removing and/or trapping syn-propanethial-S-oxide gas that is emitted from a freshly cut onion. The ventilation fan 30 is preferably attached to the cutting platform 26 through a connecting arm 32, or otherwise attached to a portion of the device such that the ventilation fan 30 is brought into sufficient proximity of the cutting platform 26 to draw air located just above the cutting platform 26 into the fan 30. Preferably, the connecting arm 32 is adjustable, such that a user may move the ventilation fan 30 closer or further from the cutting surface as is desirable. The ventilation fan 30 is preferably equipped with a filter that is capable of removing syn-propanethial-S-oxide from the air (or otherwise trapping syn-propanethial-S-oxide), such as a charcoal filter. The portable onion chopping devices of the present invention may be powered internally from a battery source or, alternatively, from an external power source (such as a standard wall power socket).

The cutting platforms and devices of the present invention, including all components thereof, may be constructed of any suitable material, such as stainless steel, glass, ceramic, plastic, other polymers, or combinations of the foregoing. Preferably, the cutting platforms and devices are constructed of a material that may be washed in conventional dish washing machines.

In other embodiments, the methods and devices of the present invention may be used for cutting other types of produce that emit noxious and/or irritating gasses. For example, the invention may be used to cut garlic, leeks, or pepper. For example, the devices and methods of the present invention may be used to cut pepper, thereby avoiding and/or reducing the extent to which a person is subjected to the irritating chemicals emitted therefrom, which causes nasal irritation, sneezing, and other undesirable symptoms.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A method for cutting an onion, which comprises the steps of:
(a) placing a cutting platform sufficiently near a heat source and ventilation hood such that air directly above the cutting platform increases in temperature and exhibits a vacuum force towards the ventilation hood when the heat source and ventilation hood are activated;
(b) activating the heat source and ventilation hood; and
(c) cutting the onion on the cutting platform.

2. The method of claim 1, wherein the heat source is a stove burner.

3. The method of claim 2, wherein the ventilation hood is positioned above, next to, or is integrated within a stove range.

4. The method of claim 3, wherein the cutting platform is positioned a predefined distance above the stove burner.

5. The method of claim 4, wherein the predefined distance is about 2 inches.

6. The method of claim 5, which further comprises (a) placing a platform base on the burner and (b) placing the cutting platform on the platform base.

7. The method of claim 3, wherein the cutting platform is positioned adjacent to at least one stove burner.

8. The method of claim 7, wherein a plane of a cutting surface of the cutting platform is positioned a predefined distance above a plane of a top side of the stove burner.

9. The method of claim 8, wherein the predefined distance is about 2 inches.

10. The method of claim 7, wherein the cutting platform is placed on a non-activated stove burner that is closest to a user, which is adjacent to an activated stove burner that is located a greater distance from the user than the non-activated burner.

11. The method of claim 10, wherein the non-activated burner is a front burner, whereas the activated burner is one or more back burners.

12. The method of claim 7, wherein the cutting platform is placed on a stove surface between two non-activated burners that are closest to a user, wherein the cutting platform is adjacent to one or more activated burners that are located a greater distance from the user than the non-activated burners.

13. The method of claim 12, wherein the non-activated burners are front burners, whereas the activated burners are one or more back burners.

14. A method for cutting onions, which comprises placing an onion on a cutting platform, applying heat to the cutting platform or air surrounding the cutting platform, and applying a vacuum pressure to the air surrounding the cutting platform.

15. A method for cutting an onion, which comprises:
(a) placing the onion on a portable cutting platform;
(b) activating a heat source that is located next to, below, or integrally formed with the cutting platform;
(c) activating a ventilation fan located next to or above the cutting platform; and
(d) cutting the onion.

16. The method of claim 15, wherein the heat source is located directly below the cutting platform.

17. The method of claim 16, wherein the ventilation fan is located above the cutting platform and is attached thereto.

18. The method of claim 17, wherein the ventilation fan is provided with a filter that is capable of trapping syn-propanethial-S-oxide gas.

19. The method of claim 18, wherein the filter is a charcoal filter.

20. The method of claim 19, wherein the heat source and ventilation fan are powered by an external or internal power source.
